(19) United States
(12) Patent Application Publication
(10) Pub. No.: US 2025/0235906 A1
(43) Pub. Date: Jul. 24, 2025

(54) DRAIN CLEANERS HAVING AN ADJUSTABLE CABLE CLAMP

(71) Applicant: Emerson Professional Tool, LLC, Elyria, OH (US)

(72) Inventors: Alex Michael Cole, Columbia Station, OH (US); Jeffrey Szucs, Ashland, OH (US)

(21) Appl. No.: 18/420,079

(22) Filed: Jan. 23, 2024

(51) Int. Cl. B08B 9/047

(52) U.S. Cl. CPC B08B 9/047; B08B 2209/04

(57) ABSTRACT

A drain cleaner includes a housing and a rotatable drum disposed in the housing. A motor is secured to the drum for rotating a drain cleaning cable. A cable clamp is secured to the drum and is rotatable with the drum. The cable clamp includes a drain cleaning cable channel for receiving the drain cleaning cable. The cable clamp is moveable between a first position in which the drain cleaning cable channel has a first depth and a second position in which the drain cleaning cable channel has a second depth.

### FIELD

The field of the disclosure relates generally to drain cleaners and, more particularly, to drain cleaner cable clamps.

### BACKGROUND

High speed drain cleaners include a flexible cable enclosed within a non-rotating sheath. The cable and sheath typically are positioned inside an annular channel of a drum. The drum rotates when the cable is pulled out from the drum. An electric motor is typically used to power the drain cleaner. The drain cleaning cable is secured to the drum by a cable clamp that is relatively close to the motor. The cable clamp secures the drain cleaning cable to the drum but allows the cable to rotate within the sheath.

The drain cleaner uses one of a number of differently sized cables (e.g., ¼ inch, 5/16 inch and/or ⅜ inch diameter cables). The drain cleaner is specifically adapted for the particular size of cable that is used (e.g., component sizing and torque limits) and cannot accommodate differently sized cables.

A need exists for drain cleaners having cable clamps that can accommodate drain cleaning cables of different diameters and that can detect the diameter of the drain cleaning cable.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a drain cleaner. The drain cleaner includes a housing and a rotatable drum disposed in the housing. A motor is secured to the drum for rotating a drain cleaning cable. A cable clamp is secured to the drum and rotatable with the drum. The cable clamp includes a drain cleaning cable channel for receiving the drain cleaning cable. The cable clamp is moveable between a first position in which the drain cleaning cable channel has a first depth and a second position in which the cleaning cable channel has a second depth. The second depth is less than the first depth.

Another aspect of the present disclosure is directed to a drain cleaner. The drain cleaner includes a housing, an outer drum disposed in the housing, and an inner drum disposed in the housing. The inner drum is rotatable relative to the housing. The inner drum and the outer drum form an annular drum channel for receiving a drain cleaning cable. The inner drum defines an inner drum chamber. A cable clamp is secured to the inner drum and rotatable with the inner drum. The cable clamp includes a drain cleaning cable channel for receiving the drain cleaning cable. The drain cleaner includes a ramp on which the cable clamp is disposed.

Yet another aspect of the present disclosure is directed to a drain cleaner. The drain cleaner includes a housing and a rotatable drum disposed in the housing. A motor is secured to the drum for rotating a drain cleaning cable. The motor is rotatable with the drum. A cable clamp is secured to the drum and rotatable with the drum. The cable clamp includes a main body and a shield plate disposed between the main body and the drum. The main body and shield plate define a drain cleaning cable channel for receiving the drain cleaning cable.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a drain cleaner;

FIG. 2 is another perspective view of the drain cleaner;

FIG. 3 is a cross-section of the drum and the drum housing of the drain cleaner;

FIG. 4 is a perspective view of the drain cleaner showing the housing chamber in which electronic components are disposed;

FIG. 5 is a front view of the drain cleaner showing the inner drum chamber;

FIG. 6 is an exploded view of the drain cleaning cable and a cleaning head of the drain cleaner;

FIG. 7 is a side view of a cable clamp of the drain cleaner in a first position;

FIG. 8 is a perspective view of the cable clamp in the first position;

FIG. 9 is a side view of the cable clamp in a second position;

FIG. 10 is a perspective view of the cable clamp in the second position;

FIG. 11 is a detailed perspective view of the drain cleaner showing the cable clamp in the first position;

FIG. 12 is a detailed perspective view of the drain cleaner showing a position sensor;

FIG. 13 is a block diagram showing control of the motor of the drain cleaner;

FIG. 14 is a detailed perspective view of the drain cleaner showing the cable clamp extending into the annular drum channel;

FIG. 15 is a cross-section of the drain cleaner showing the cable clamp and a ramp on which the cable clamp is disposed.

Corresponding reference characters indicate corresponding parts throughout the drawings.

### DETAILED DESCRIPTION

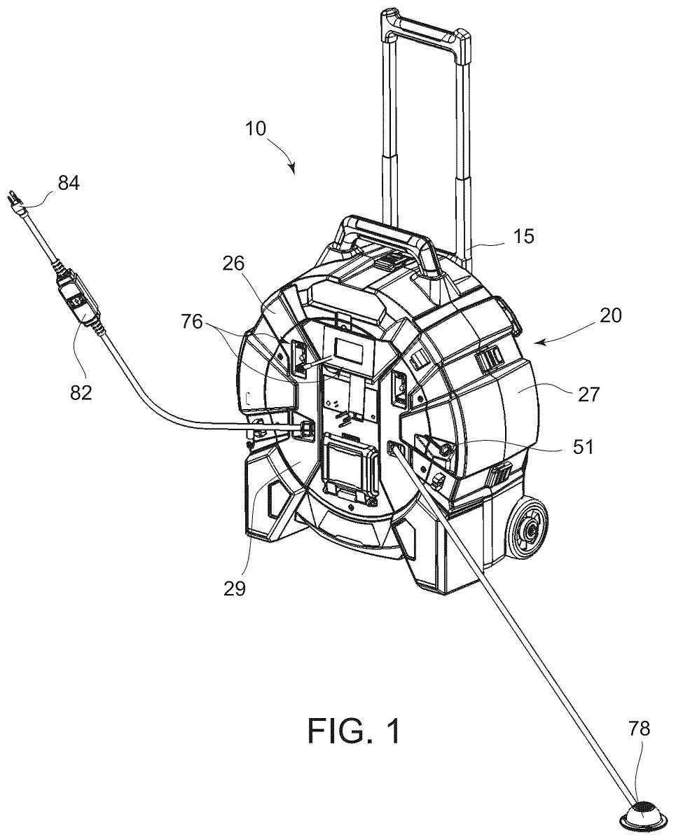

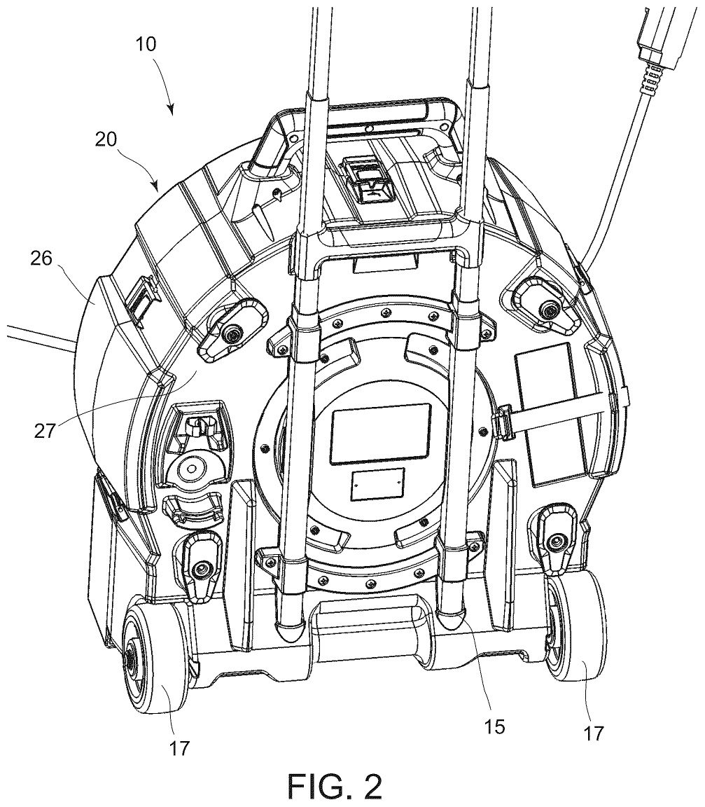

An embodiment of a drain cleaner 10 is shown in FIGS. 1-14. The drain cleaner 10 is shown in a vertical orientation and includes an optional cart 15. The drain cleaner 10 is selectively attachable, detachable, and/or releasable from the cart 15. The drain cleaner 10 includes at least one wheel 17 (FIG. 2) and typically utilizes two, four or six wheels. The drain cleaner 10 is typically operated in a horizontal orientation (e.g., may include a bearing that accommodates axial loads when the drain cleaner 10 is operated in a horizontal orientation). The drain cleaner 10 may include features and components disclosed in U.S. Patent Publication No. 2021/0172162, which is incorporated herein by reference for all relevant and consistent purposes.

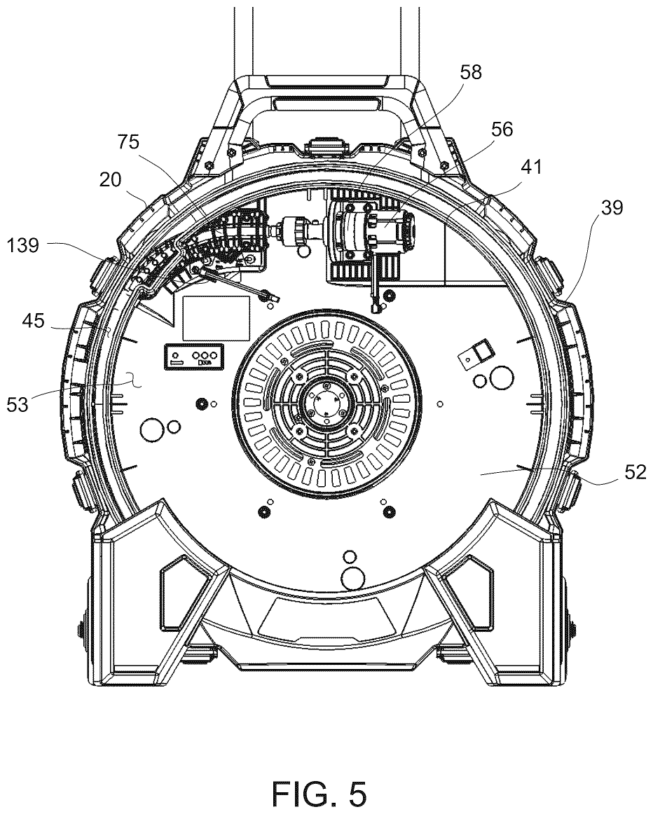

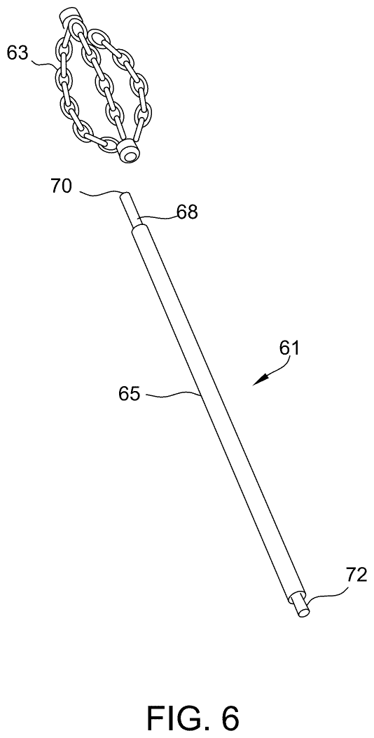

The drain cleaner 10 operates by rotating a cleaning head 63 (FIG. 6) as the cleaning head 63 moves through a drain. In the illustrated embodiment, the cleaning head 63 is connected to a drain cleaning cable 61 that includes a sheath 65 and a cable 68 positioned within the sheath 65. The cable 68 rotates relative to the sheath 65. The cable 68 connects to the cleaning head 63 at a distal end 70 of the cable 68. The cable 68 also connects to the output of a gear box 58 (FIG. 5) at a proximal end 72 of the cable 68. While the present disclosure describes a drain cleaning cable having a cable that rotates within a sheath, other types of drain cleaning cables could be used.

The drain cleaner 10 includes a drum housing 20 (FIG. 1). The drum housing 20 is generally cylindrical. The drum housing 20 includes a front housing segment 26 and a rear housing segment 27. The front housing segment 26 includes a front segment housing cover 29.

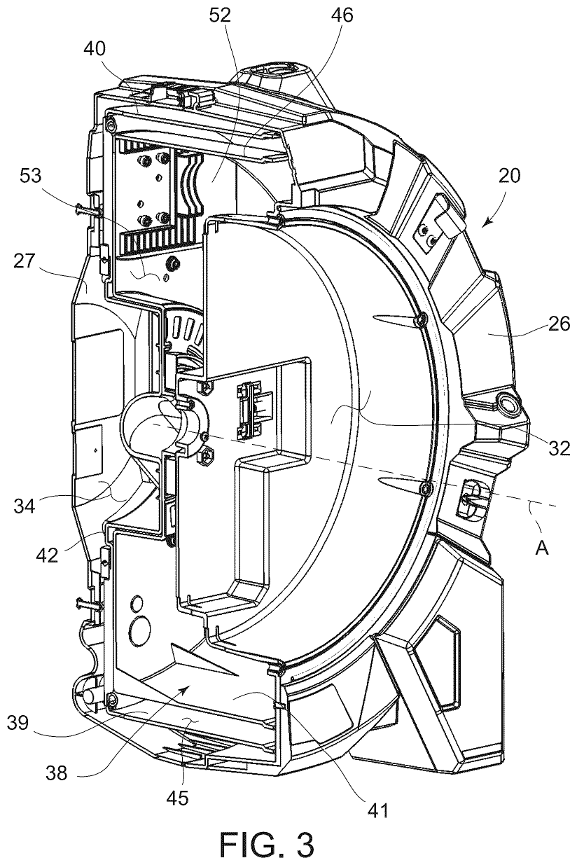

The cover 29 encloses a front segment housing chamber 32 (FIG. 3) in which a various electronic components (e.g., motor controller) are disposed. The front housing segment 26 and the rear housing segment 27 form a housing chamber 34 in which a rotatable drum 38 is disposed.

The rotatable drum 38 includes an outer drum 39 and an inner drum 41 disposed within the outer drum 39. The inner drum 41 and outer drum 39 are rotatable relative to the drum housing 20 and rotate about axis A. The outer drum 39 and inner drum 41 are both cylindrically shaped. The inner drum 41 is concentrically positioned within the outer drum 39. The outer drum 39 and the inner drum 41 form an annular drum channel 45 for receiving the drain cleaning cable 61 (FIG. 6). The drain cleaning cable 61 is disposed within the annular drum channel 45 and moves in and out of the drum housing 20 (FIG. 1) as the inner drum 41 and outer drum 39 rotate. The drum housing 20 includes a cable port 51 through which the cable passes during cleaning operations of the drain cleaner 10.

The drain cleaner 10 may include drum support assemblies (not shown) that support the outer drum 39 and inner drum 41 and may include a bearing disposed between the primary and secondary support assemblies that enables the drum 38 to rotate relative to the housing 20.

The outer drum 39 includes an annular partition 40 and a basewall 42 that extends radially inward from the annular partition 40 toward the axis of rotation A of the inner drum 41. The inner drum 41 includes an annular partition 46 and a basewall 52 that extends radially inward from the annular partition 46 toward the axis of rotation A of the inner drum 41. The inner drum 41 defines an inner drum chamber 53 in which various components that rotate with the inner drum 41 are disposed.

Referring now to FIG. 5, the drain cleaner 10 includes an electric motor 56 secured to the inner drum 41 and disposed within the inner drum chamber 53. The motor 56 rotates with the inner drum 41. In some embodiments, the drain cleaner 10 includes a counterweight secured to the inner drum 41 and disposed within the inner drum chamber 53. The drain cleaner 10 includes a gear box 58 connected to the motor 56 (e.g., connected to a rotary output of the motor 56). The gear box 58 rotates with the inner drum 41.

The drain cleaner 10 includes a cable clamp 75 secured to the inner drum 41 and disposed within the inner drum chamber 53. The cable clamp 75 is positioned over at least a region or portion of the drain cleaning cable 61 (FIG. 6). The cable clamp 75 rotates with the inner drum 41.

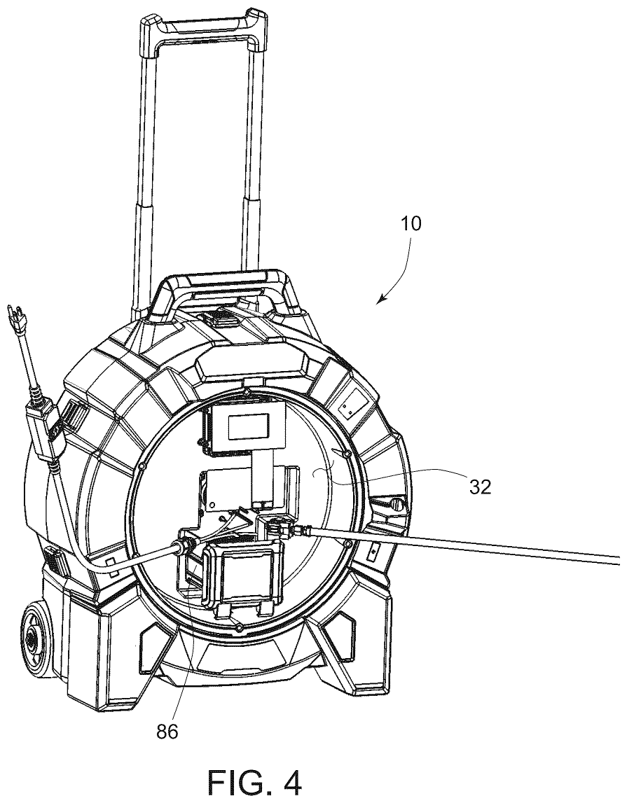

The drain cleaner 10 includes various controls and/or indicators 76 (FIG. 1). Specifically, the controls and indicators 76 can include one or more selector switches and electrical circuit breakers. The drain cleaner 10 may also optionally include a foot operated switch 78 for governing operation of the drain cleaner 10. The drain cleaner 10 includes components and circuitry for signal and/or power delivery between the housing cover 29 and the motor 56. The drain cleaner 10 includes a power cord assembly 82 having a plug 84 to connect the drain cleaner to mains power. The power cord assembly 82 also includes one or more switches and ground fault circuit interrupter (GFCI). The drain cleaner 10 also includes a battery 86 (FIG. 4) that may also be used to power the motor 56 (FIG. 5). The motor 56 is selectively powered by mains power or by the battery.

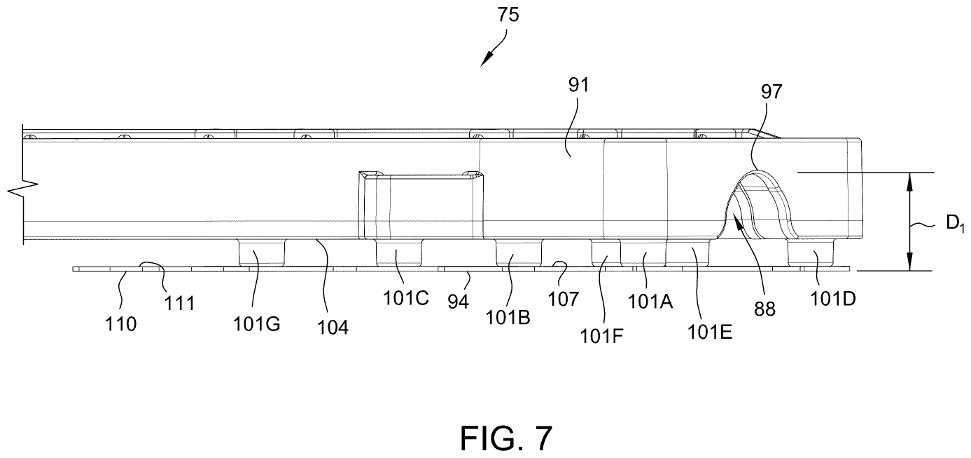

Referring now to FIG. 7, the cable clamp 75 includes a drain cleaning cable channel 88 for receiving the drain cleaning cable 61 (FIG. 6). In the illustrated embodiment, the channel 88 is u-shaped. Other embodiments of the cable clamp 75 may include a v-shaped channel 88.

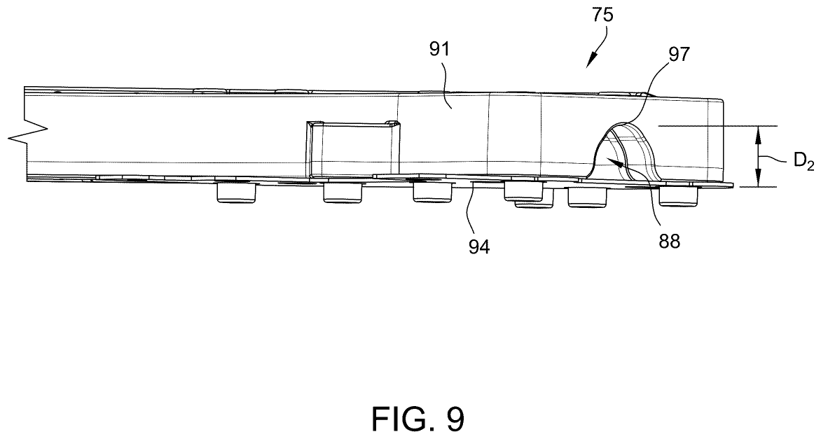

The cable clamp 75 is adapted to accommodate cables of different sizes. For example, the cable clamp 75 may be capable of clamping both a ¼ inch and 5/16 inch cables. Alternatively or in addition, the cable clamp may be capable of clamping ⅜ inch cables. The cable clamp 75 may clamp different sizes of cables or may be configured to accommodate more than 2 different sizes of cables (e.g., 3, 4, 5 or more different cable sizes). In the illustrated embodiment, the cable clamp 75 is moveable between a first position (FIG. 7) in which the drain cleaning cable channel 88 has a first depth D₁ and a second position (FIG. 9) in which the drain cleaning cable channel 88 has a second depth D₂. The second depth D₂ is less than the first depth D₂.

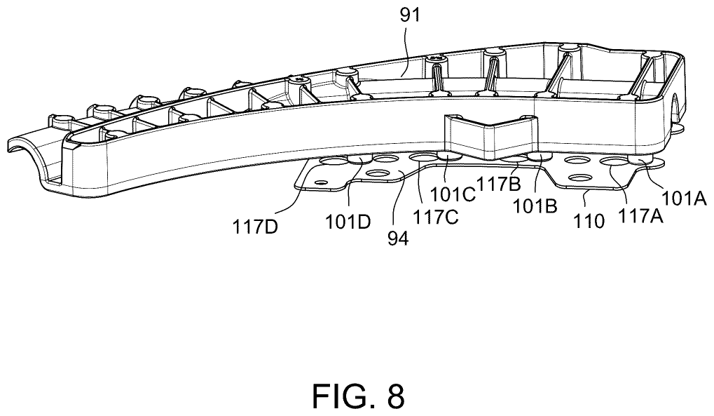

In the illustrated embodiment, the cable clamp 75 includes a main body 91 and a shield plate 94 disposed between the main body 91 and the sidewall 52 (FIG. 5) of the inner drum 41. In some embodiments, the main body 91 is made of a polymer and the shield plate 94 is a metal such as stainless steel. In other embodiments, the shield plate 94 is a polymer. The first depth D₁ and the second depth D₂ of the drain cleaning cable channel 88 correspond to the distance between an apex 97 of the drain cleaning cable channel 88 and the shield plate 94. As shown in FIG. 7 in which the first position of the cable clamp 75 is shown, the main body 91 includes a plurality of guide posts 101A-G that extend from a lower surface 104 of the main body 91. In the first position (FIGS. 7-8), the guide posts 101A-G contact the top surface 111 of a base 110. In the illustrated embodiment, the base 110 is the shield plate 94. In other embodiments, the base 110 may be the basewall 52 of the inner drum 41.

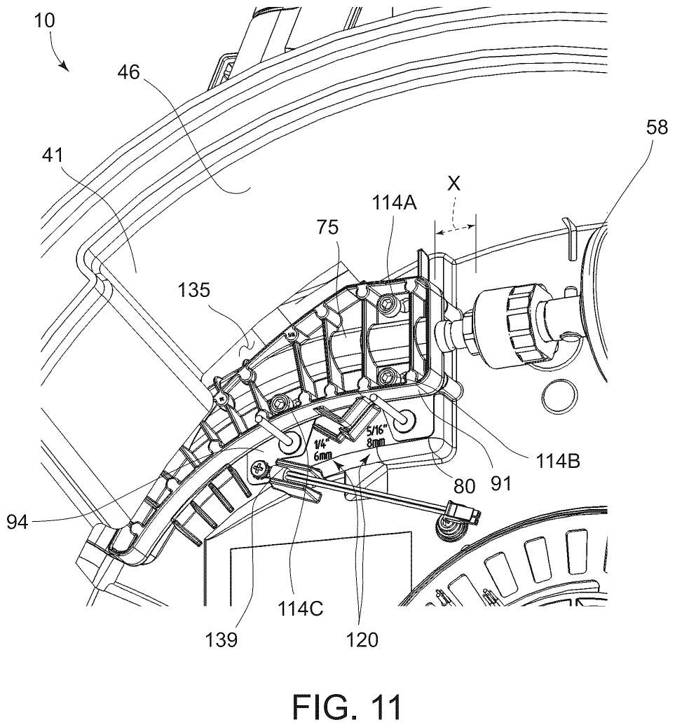

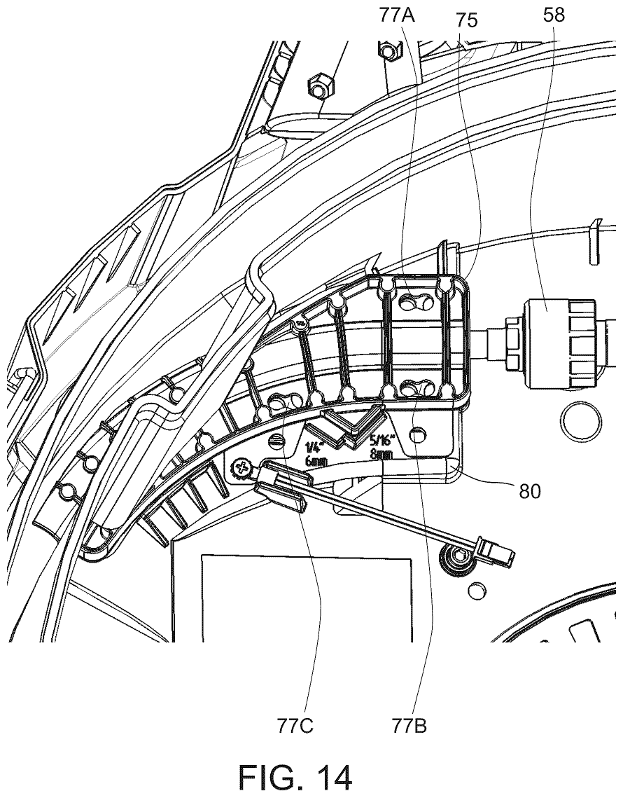

The cable clamp 75 includes one or more cable clamp fasteners 114A-C (FIG. 11) that enable a clamping force to be applied to the drain cleaning cable when the cable clamp 75 is in the first position or the second position. The cable clamp 75 includes cable clamp apertures 77A-C (FIG. 14), through which the fasteners 114A-C extend. The apertures 77A-C include two lobes (i.e., are peanut shaped) for receiving the fasteners 114A-C in both the first and second positions of the cable clamp 75. The lobes bias the clamp 75 in either the first position or the second position (i.e., the fastener can be positioned in an intermediate portion of the aperture 77).

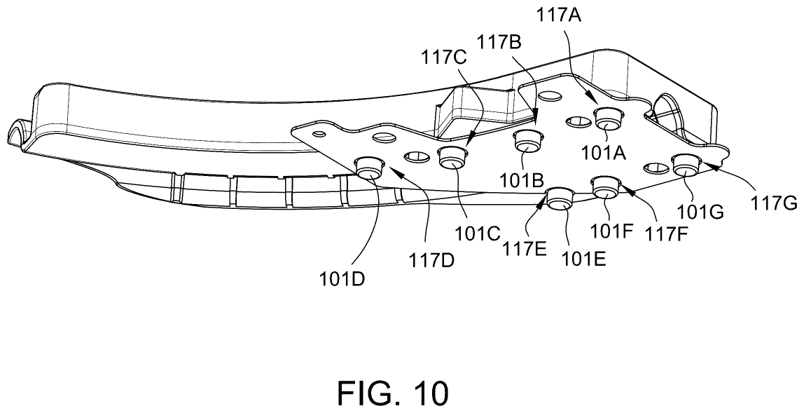

To move the cable clamp 75 to the second position, the one or more cable clamp fasteners 114A-C (FIG. 11) are removed and the main body 91 of the cable clamp is moved away from the gear box 58. The main body 91 is moved until the guide posts 110A-G align with recesses 117A-G (FIGS. 8 and 10). The main body 91 is lowered and each guide posts 110A-G is received in the corresponding recess 117A-G. Because the guide posts 110A-G are disposed within the recesses 117A-G, the depth D₂ of the cable clamp channel 88 is reduced and the cable clamp 75 is capable of clamping smaller diameter cables in the second position.

In addition to the depth of the cable clamp channel 88 changing as the clamp 75 is moved between the first and second positions, the distance X (FIG. 11) between the cable clamp 75 and the gear box 58 changes between the first and second positions. The cable clamp 75 is spaced from the gear box 58 by a first distance in the first position and by a second distance in the second position with the first distance being less than the second distance. The drain cleaner 10 includes indicators 120 that are axially spaced to indicate which size cable the clamp can accommodate at the relative position of the cable clamp 75 (i.e., first position of the clamp 75 being “ 5/16 8 mm” and the second position being “¼ 6 mm”).

In other embodiments, the relative position of the guide posts 101A-G and apertures 117A-G is configured such that the first distance is greater than the second distance. In yet other embodiments, the distance X does not change (e.g., with spacers being used to adjust the depth of the cable clamp channel 88).

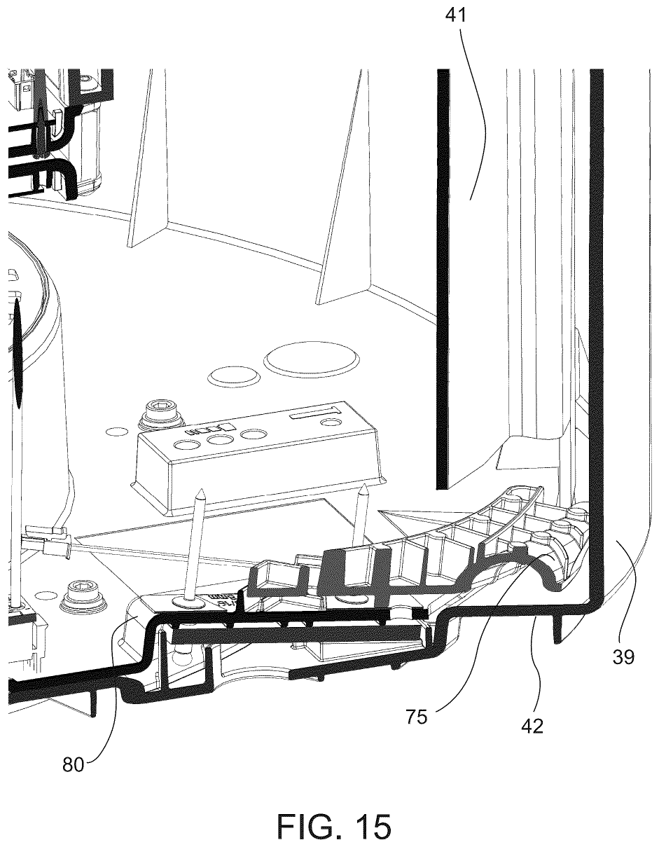

The cable clamp 75 is disposed on an inclined ramp 80 (FIG. 15). The ramp 80 angles the cable 61 down from its position at the gear box 58 to the lower position of the basewall 42 of the outer drum 39.

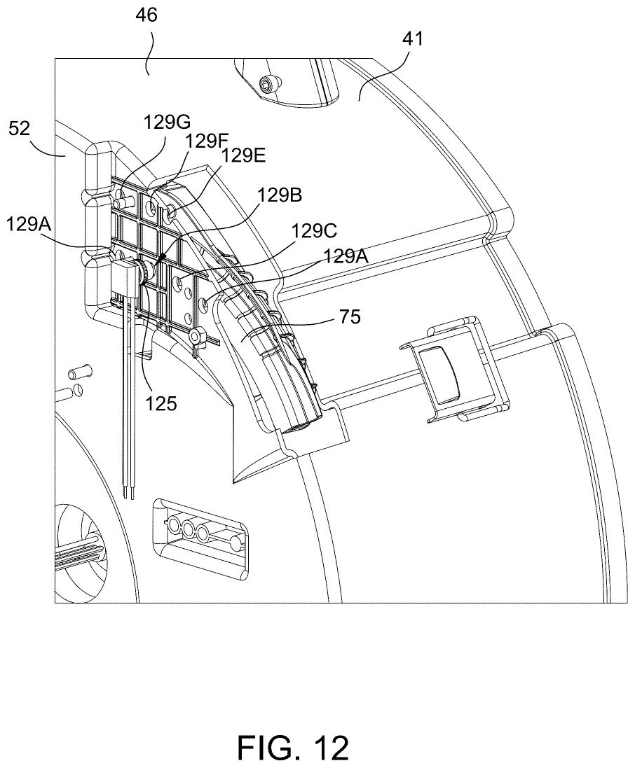

Referring now to FIG. 12, the drain cleaner 10 includes a position sensor 125 that senses whether the cable clamp 75 is in the first position or is in the second position. In the illustrated embodiment, the position sensor 125 is a limit switch. Other types of switches may also be used including proximity sensors, optical sensors, inductive sensors, hall effect sensors and eddy current sensors.

The inner drum 41 includes inner drum apertures 129A-G that receive the guide posts 101A-G (FIG. 10) when the cable clamp 75 is in the second position (i.e., each guide post 101A-G passes through a corresponding base aperture 117A-G and a corresponding inner drum aperture 129A-G). The position sensor 125 is aligned with the second inner drum aperture 129B and the second base aperture 117B such that the second guide post 101B triggers the position sensor 125 when the clamp 75 is in the second position.

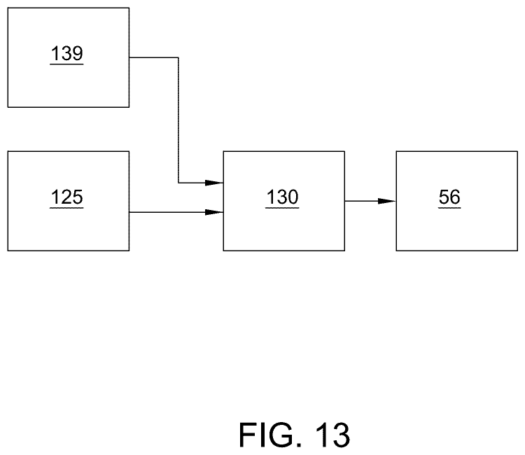

As shown in FIG. 13, the position sensor 125 is communicatively coupled to a controller 130 (e.g., motor control board). The controller 130 is programmed to adjust one or more drain cleaning parameters based on the position of the cable clamp 75 (i.e., the size of the cable used in the drain cleaner 10). For example, the controller 130 may change a maximum motor torque and/or the motor speed based on the position of the cable clamp 75.

The drain cleaning cable 61 (FIG. 6) extends from the cable clamp 75 (FIG. 5) and wraps around the inner drum 41 in the annular drum channel 45. As shown in FIG. 5, the cable clamp 75 extends from the inner drum chamber 53 and into the annular drum channel 45. As shown in FIG. 11, the inner drum 41 includes a notch 135 that extends through the inner drum annular partition 46. The cable clamp 75 extends through the notch 135.

In the illustrated embodiment, the drain cleaner 10 includes a temperature sensor 139 (FIG. 11) that senses the temperature of the shield plate 94. As shown in FIG. 13, the temperature sensor 139 is communicatively coupled to the controller 130. The controller 130 is programed to (1) adjust the motor speed, (2) engage a motor shut down operation, and/or (3) change a maximum motor torque based on the temperature of the shield plate 94. The temperature sensor 139 is optional and other embodiments of the drain cleaner 10 do not include a temperature sensor.

Compared to conventional drain cleaners, the drain cleaner of embodiments of the present disclosure have several advantages. Use of a cable clamp that is adjustable between first and second positions with the depth of the cable clamp channel within the clamp being different in the first and second positions enables two or more cable sizes to be clamped (e.g., ¼ inch, 5/16 inch and/or ⅜ inch). Use of a position sensor that senses the position the cable clamp enables the drain cleaner to change one or more drain cleaning parameters based on the position of the clamp (e.g., maximum motor torque and/or the motor speed). The shield plate of the cable clamp may be metal which protects the drum in the event of a cable failure. Use of a temperature sensor connected to the shield plate allows the operation of the cable to be monitored. A temperature signal can be sent to the controller to adjust the drain cleaner based on the sensed temperature. The adjustable cable clamp allows only the cable to be changed when it is desirable to change cable sizes (e.g., no additional drum is used).

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A drain cleaner comprising:
a housing;
a rotatable drum disposed in the housing;
a motor secured to the drum for rotating a drain cleaning cable; and
a cable clamp secured to the drum and rotatable with the drum, the cable clamp comprising a drain cleaning cable channel for receiving the drain cleaning cable, the cable clamp being moveable between a first position in which the drain cleaning cable channel has a first depth and a second position in which the cleaning cable channel has a second depth, the second depth being less than the first depth.

2. The drain cleaner as set forth in claim 1 wherein the cable clamp further comprises:
a plurality of guide posts; and
a base having a top surface and a plurality of recesses for receiving the plurality of guide posts, each guide post contacting the top surface of the base when the cable clamp is in the first position, each guide post being disposed within a recess when the cable clamp is in the second position.

3. The drain cleaner as set forth in claim 2 comprising one or more fasteners that enable a clamping force to be applied to the drain cleaning cable when the cable clamp is in one of the first position and the second position.

4. The drain cleaner as set forth in claim 1 further comprising a gear box connected to the motor that rotates with the drum, the cable clamp being spaced from the gear box by a first distance in the first position and spaced from the gear box by a second distance in the second position, the first distance being less than the second distance.

5. The drain cleaner as set forth in claim 1 wherein the cable clamp comprises:
a main body; and
a shield plate disposed between the main body and the drum, the first depth and the second depth of the drain cleaning cable channel being the distance between an apex of the drain cleaning cable channel and the shield plate.

6. The drain cleaner as set forth in claim 1 wherein the drum comprises an inner drum and an outer drum, the inner drum and outer drum being rotatable relative to the housing, the inner drum and the outer drum forming an annular drum channel for receiving the drain cleaning cable, the motor and cable clamp being secured to the inner drum.

7. The drain cleaner as set forth in claim 1 comprising a position sensor that senses whether the cable clamp is in the first position or is in the second position.

8. The drain cleaner as set forth in claim 7 wherein the position sensor is communicatively coupled to a controller, the controller being programed to adjust one or more drain cleaning parameters based on the position of the cable clamp.

9. The drain cleaner as set forth in claim 8 wherein the one or more drain cleaning parameters include (1) a maximum motor torque, and/or (2) motor speed.

10. The drain cleaner as set forth in claim 7 wherein the position sensor is a limit switch.

11. The drain cleaner as set forth in claim 1 wherein the motor is rotatable with the drum.

12. A drain cleaner comprising:
a housing;
an outer drum disposed in the housing;
an inner drum disposed in the housing, the inner drum being rotatable relative to the housing, the inner drum and the outer drum forming an annular drum channel for receiving a drain cleaning cable, the inner drum defining an inner drum chamber;
a cable clamp secured to the inner drum and rotatable with the inner drum, the cable clamp comprising a drain cleaning cable channel for receiving the drain cleaning cable; and
a ramp on which the cable clamp is disposed.

13. The drain cleaner as set forth in claim 12 wherein the outer drum has a basewall, the drain cleaner comprising a gear box, the ramp angling the cable clamp downward from its position at the gear box to the basewall of the outer drum.

14. The drain cleaner as set forth in claim 12 wherein the cable clamp is moveable between a first position in which the drain cleaning cable channel has a first depth and a second position in which the drain cleaning cable channel has a second depth, the second depth being less than the first depth.

15. A drain cleaner comprising:
a housing;
a rotatable drum disposed in the housing;
a motor secured to the drum for rotating a drain cleaning cable, the motor being rotatable with the drum;
a cable clamp secured to the drum and rotatable with the drum, the cable clamp comprising:
a main body; and
a shield plate disposed between the main body and the drum, the main body and shield plate defining a drain cleaning cable channel for receiving the drain cleaning cable.

16. The drain cleaner as set forth in claim 15 wherein the main body is made of a polymer and the shield plate is made of metal.

17. The drain cleaner as set forth in claim 16 wherein the drum comprises an inner drum and an outer drum, the inner drum and outer drum being rotatable relative to the housing, the inner drum and the outer drum forming an annular drum channel for receiving the drain cleaning cable, the motor and cable clamp being secured to the inner drum, the inner drum comprising:
an annular partition; and
a sidewall that extends radially inward from the annular partition, the shield plate being disposed between the sidewall and the main body of the cable clamp.

18. The drain cleaner as set forth in claim 15 further comprising a temperature sensor that senses the temperature of the shield plate.

19. The drain cleaner as set forth in claim 18 wherein the temperature sensor is communicatively coupled to a controller, the controller being programed to (1) adjust the motor speed, (2) engage a motor shut down operation and/or (3) change a maximum motor torque based on the temperature of the shield plate.

20. The drain cleaner as set forth in claim 15 wherein the cable clamp is moveable between a first position in which the drain cleaning cable channel has a first depth and a second position in which the drain cleaning cable channel has a second depth, the second depth being less than the first depth.
